(19) United States
(12) Patent Application Publication
(10) Pub. No.: US 2022/0270327 A1
(43) Pub. Date: Aug. 25, 2022

(54) SYSTEMS AND METHODS FOR BOUNDING BOX PROPOSAL GENERATION

(71) Applicants: Denso International America, Inc., Southfield, MI (US); Carnegie Mellon University, Pittssburgh, PA (US)

(72) Inventors: Prasanna Sivakumar, Pittsburgh, PA (US); Kris Kitani, Pittsburgh, PA (US); Matthew O' Toole, Pittsburgh, PA (US); Yunze Man, Pittsburgh, PA (US); Xinshuo Weng, Pittsburgh, PA (US)

(21) Appl. No.: 17/183,666

(22) Filed: Feb. 24, 2021

(51) Int. Cl. G06T 19/00

(52) U.S. Cl. CPC G06T 19/00; G06T 2210/56; G06T 2210/12

(57) ABSTRACT

Systems, methods, and other embodiments described herein relate to generating bounding box proposals. In one embodiment, a method includes generating blended 2-dimensional (2D) data based on 2D data and 3-dimensional (3D) data, and generating blended 3D data based on the 2D data and the 3D data. The method includes generating 2D features based on the 2D data and the blended 2D data, generating 3D features based on the 3D data and the blended 3D data, and generating the bounding box proposals based on the 2D features and the 3D features.

### TECHNICAL FIELD

The subject matter described herein relates in general to systems and methods for generating bounding box proposals.

### BACKGROUND

Perceiving an environment can be an important aspect for many different computational functions, such as automated vehicle assistance systems. However, accurately perceiving the environment can be a complex task that balances computational costs, speed of computations, and an extent of accuracy. For example, as a vehicle moves more quickly, the time in which perceptions are to be computed is reduced since the vehicle may encounter objects more quickly. Additionally, in complex situations, such as intersections with many dynamic objects, the accuracy of the perceptions may be preferred. In any case, processing systems are generally configured to use a single type of sensor data, where the type can be 2-dimensional (2D) images or 3-dimensional (3D) point clouds. However, neither approach alone is generally well suited for computational efficiency and accurate determinations.

### SUMMARY

In one embodiment, a method for generating bounding box proposals is disclosed. The method includes generating blended 2D data based on 2D data and 3D data, and generating blended 3D data based on the 2D data and the 3D data. The method includes generating 2D features based on the 2D data and the blended 2D data, generating 3D features based on the 3D data and the blended 3D data, and generating the bounding box proposals based on the 2D features and the 3D features.

In another embodiment, a system for generating bounding box proposals is disclosed. The system includes a processor and a memory in communication with the processor. The memory stores a feature blending module including instructions that when executed by the processor cause the processor to generate blended 2D data based on 2D data and 3D data, generate blended 3D data based on the 2D data and the 3D data, generate 2D features based on the 2D data and the blended 2D data, and generate 3D features based on the 3D data and the blended 3D data. The memory stores a proposal generation module including instructions that when executed by the processor cause the processor to generate the bounding box proposals based on the 2D features and the 3D features.

In another embodiment, a non-transitory computer-readable medium for generating bounding box proposals and including instructions that when executed by a processor cause the processor to perform one or more functions, is disclosed. The instructions include instructions to generate blended 2D data based on 2D data and 3D data, generate blended 3D data based on the 2D data and the 3D data, generate 2D features based on the 2D data and the blended 2D data, generate 3D features based on the 3D data and the blended 3D data, and generate the bounding box proposals based on the 2D features and the 3D features.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of an object detection system that includes a bounding box proposal generation system.

FIG. 2 illustrates one embodiment of the bounding box proposal generation system.

FIG. 3 illustrates one embodiment of a dataflow associated with generating bounding box proposals.

FIG. 4 illustrates one embodiment of a method associated with generating bounding box proposals.

FIG. 5 illustrates an example of a bounding box proposal scenario with a sensor located at a crosswalk.

### DETAILED DESCRIPTION

Systems, methods, and other embodiments associated with generating bounding box proposals are disclosed.

Object detection processes can include the use of bounding box proposals. Bounding box proposals are markers that identify regions within an image that may have an object. Thus, bounding box proposals can be used to solve object localization more efficiently. As such, object detection processes can typically perform object classification in the regions identified by the bounding box proposals, making the process more efficient.

In various approaches, bounding box proposals can be generated based on 2-dimensional (2D) images. Alternatively, bounding box proposals can be generated based on 3-dimensional (3D) point clouds. However, bounding box proposals generated based on only 2D images and bounding box proposals generated based on only 3D point clouds may be limited in accuracy.

Accordingly, in one embodiment, the disclosed approach is a system that generates bounding box proposals based on a combination of 2D images and 3D point clouds for increased accuracy.

The system can receive sensor data from, as an example, a SPAD (Single Photon Avalanche Diode) LiDAR sensor. The sensor data include both 2D and 3D information, where the 2D and 3D information are related and/or synchronized. The system can extract the 2D information and the 3D information from the sensor data. Based on the extracted 2D information and the extracted 3D information, the system can generate blended 2D data and blended 3D data. The system can generate 2D feature maps based on the blended 2D data and the extracted 2D information. Similarly, the system can generate 3D feature maps based on the blended 3D data and the extracted 3D information.

The system can generate anchor boxes based on the 2D feature maps and the 3D feature maps. The anchor boxes are defined to capture the scale and aspect ratio of specific object classes that are of interest in the object detection process. The system can determine the bounding box proposals based on applying machine learning algorithms to the anchor boxes.

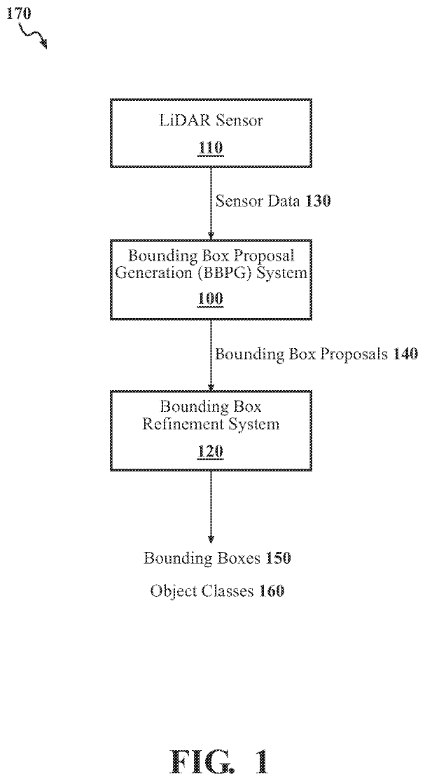

Referring to FIG. 1, one embodiment of an object detection system 170 that includes a bounding box proposal generation (BBPG) system 100 is illustrated. The object detection system 170 also includes a LiDAR sensor 110 and a bounding box refinement system 120. The LiDAR sensor 110 outputs sensor data 130 based on its environment. The BBPG system 100 receives the sensor data 130 from the LiDAR sensor 110. The BBPG system 100 processes the sensor data 130, extracting 2D and 3D information from the sensor data 130. The BBPG system 100 applies any suitable machine learning mechanisms to the extracted 2D and 3D information to generate the bounding box proposals 140. The bounding box refinement system 120 receives the bounding box proposals 140, and determines a final representation for the bounding box 150 of an object as well as an object class 160 for the object based on the bounding box proposals 140.

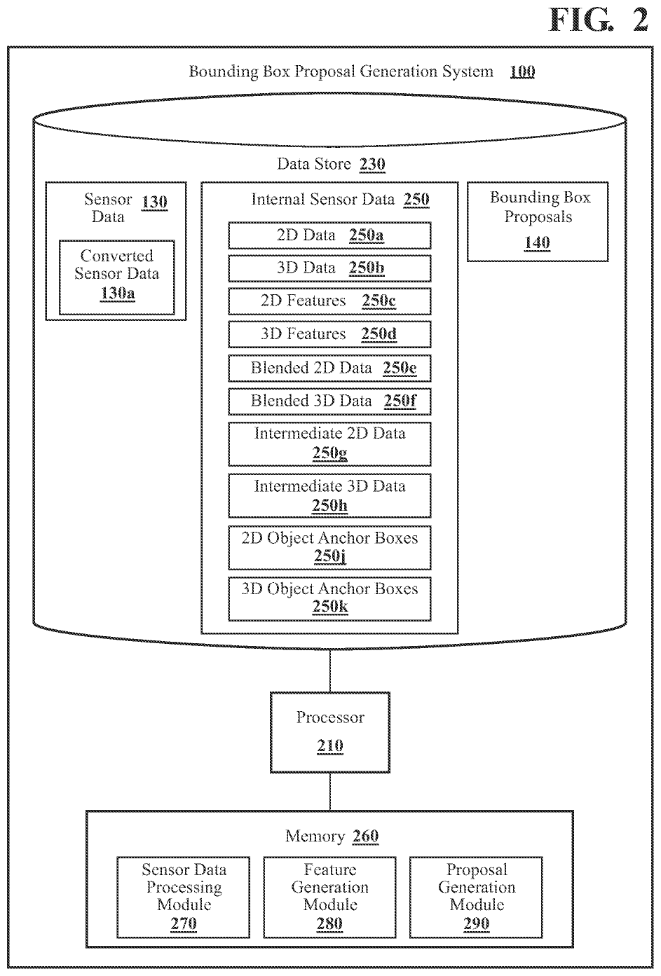

Referring to FIG. 2, one embodiment of a BBPG system 100 is illustrated. As shown, the BBPG system 100 includes a processor 210. Accordingly, the processor 210 may be a part of the BBPG system 100, or the BBPG system 100 may access the processor 210 through a data bus or another communication pathway. In one or more embodiments, the processor 210 is an application-specific integrated circuit that is configured to implement functions associated with a sensor data processing module 270, a feature generation module 280, and a proposal generation module 290. More generally, in one or more aspects, the processor 210 is an electronic processor such as a microprocessor that is capable of performing various functions as described herein when executing encoded functions associated with the BBPG system 100.

In one embodiment, the BBPG system 100 includes a memory 260 that can store a sensor data processing module 270, a feature generation module 280, and a proposal generation module 290. The memory 260 is a random-access memory (RAM), read-only memory (ROM), a hard disk drive, a flash memory, or other suitable memory for storing the modules 270, 280 and 290. The modules 270, 280, and 290 are, for example, computer-readable instructions that, when executed by the processor 210, cause the processor 210 to perform the various functions disclosed herein. While, in one or more embodiments, the modules 270, 280, and 290 are instructions embodied in the memory 260, in further aspects, the modules 270, 280, and 290 include hardware, such as processing components (e.g., controllers), circuits, et cetera for independently performing one or more of the noted functions.

Furthermore, in one embodiment, the BBPG system 100 includes a data store 230. The data store 230 is, in one embodiment, an electronically-based data structure for storing information. In one approach, the data store 230 is a database that is stored in the memory 260 or another suitable storage medium, and that is configured with routines that can be executed by the processor 210 for analyzing stored data, providing stored data, organizing stored data, and so on. In any case, in one embodiment, the data store 230 stores data used by the modules 270, 280, and 290 in executing various functions. In one embodiment, the data store 230 includes sensor data 130, internal sensor data 250, bounding box proposals 140, along with, for example, other information that is used by the modules 270, 280, and 290.

In general, “sensor data” means any information that embodies observations of one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process. Further, “internal sensor data” means any sensor data that is being processed and used for further analysis within the BBPG system 100.

The BBPG system 100 can be operatively connected to the one or more sensors. More specifically, the one or more sensors can be operatively connected to the processor(s) 210, the data store(s) 230, and/or another element of the BBPG system 100. In one embodiment, the sensors can be internal to the BBPG system 100, external to the BBPG system 100, or a combination thereof.

The sensors can include any type of sensor capable of generating 2D sensor data such as ambient images and/or 3D sensor data such as 3D point clouds. Various examples of different types of sensors will be described herein. However, it will be understood that the embodiments are not limited to the particular sensors described. As an example, in one or more arrangements, the sensors can include one or more LiDAR sensors, and one or more cameras. The LiDAR sensors can include conventional LiDAR sensors capable of generating 3D point clouds and/or LiDAR sensors capable of generating both 2D images and 3D point clouds such as Single Photon Avalanche Diode (SPAD) based LiDAR sensors. In one or more arrangements, the cameras, capable of generating 2D images, can be high dynamic range (HDR) cameras or infrared (IR) cameras.

In one embodiment, the sensor data processing module 270 includes instructions that function to control the processor 210 to generate 2D data 250a and 3D data 250b based on sensor data 130. The sensor data processing module 270 can acquire the sensor data 130 from the sensors. The sensor data processing module 270 may employ any suitable techniques that are either active or passive to acquire the sensor data 130. As an example, the sensor data processing module 270 can receive sensor data 130 that includes 2D and 3D information from a single source such as a SPAD based LiDAR sensor. As another example, the sensor data processing module 270 can receive sensor data 130 from multiple sources. In such an example, the sensor data 130 can include 2D information from a camera and sensor data 130 that includes 3D information from a LiDAR sensor. The sensor data processing module 270 can synchronize the 2D information from the camera and the 3D information from the LiDAR sensor.

In one embodiment and as an example, the sensor data processing module 270 can convert the sensor data 130 into a 2D format and a 3D format. In such an example, each point in the converted sensor data 130a is represented in a 2D format by intensity and ambient pixel integer values (e.g., between 0-255), and in a 3D format by Cartesian co-ordinates (e.g., in the X-, Y-, Z-plane).

The sensor data processing module 270 can generate 2D data 250a and 3D data 250b based on the converted sensor data in the 2D format and the 3D format respectively. The sensor data processing module 270 can apply any suitable algorithm to extract the 2D data 250a and the 3D data 250b from the converted sensor data 130a. As an example, the sensor data processing module 270 can extract light intensity information, ambient light information, and depth information from the converted sensor data 130a in the 2D format. As such, the 2D data 250a can include 2D intensity images, 2D ambient images, and/or 2D depth maps. As a further example, the sensor data processing module 270 can extract 3D point cloud information from the converted sensor data 130a in the 3D format. As such, the 3D data 250b can include 3D point cloud information.

The sensor data processing module 270 can be internal to the BBPG system 100. Alternatively, the sensor data processing module 270 can be external to the BBPG system 100. In another embodiment, one portion of the sensor data processing module 270 can be internal to the BBPG system 100 and another portion of the sensor data processing module 270 can be external to the BBPG system 100.

The feature generation module 280 includes instructions that function to control the processor 210 to generate 2D features 250c and 3D features 250d based on a combination of the 2D data 250a and the 3D data 250b. As an example, the feature generation module 280 can acquire the 2D data 250a and the 3D data 250b from the sensor data processing module 270. In such an example and as mentioned above, the feature generation module 280 can receive 2D data 250a that includes the 2D intensity images, the 2D ambient images and the 2D depth maps from the sensor data processing module 270. The feature generation module 280 can also receive 3D data 250b that includes 3D pointcloud information from the sensor data processing module 270.

The feature generation module 280 includes instructions that function to control the processor 210 to generate the 2D features 250c based on the 2D data 250a and blended 2D data 250e. The 2D features can include segmentation masks, 3D object orientation estimates, and 2D bounding boxes. A segmentation mask is the output of instance segmentation. Instance segmentation is the process of identifying boundaries of potential objects in an image and associating pixels in the image with one of the potential objects. A 3D object orientation estimate is an estimate of the 3D orientation of an object in an image. The 3D object orientation estimate can indicate the relationship between the objects identified in the image. A 2D bounding box is a bounding box in a 2D format.

The feature generation module 280 includes instructions that function to control the processor 210 to generate the 3D features 250d based on the 3D data 250b and blended 3D data 250f. The 3D features can include 3D object center location estimates. A 3D object center location estimate is the estimated distance between the capturing sensor and the estimated center of the object.

The feature generation module 280 includes instructions that function to control the processor 210 to generate intermediate 2D data 250g based on the 2D data 250a. The feature generation module 280 can use any suitable machine learning techniques to extract the intermediate 2D data 250g from the 2D data 250a. Intermediate 2D data 250g is data that includes relevant information about the received 2D data 250a such as 2D feature maps that can include texture information and semantic information. Intermediate 2D data 250g can be used for machine learning and further processing mechanisms.

The feature generation module 280 also includes instructions that function to control the processor 210 to generate intermediate 3D data 250h based on the 3D data 250b. The feature generation module 280 can use any suitable machine learning techniques to extract the intermediate 3D data 250h from the 3D data 250b. Intermediate 3D data 250h is data that includes relevant information about the received 3D data 250b such as pixel-wise feature maps. Similar to intermediate 2D data 250g, intermediate 3D data 250h can be used for machine learning and further processing mechanisms.

Further, the feature generation module 280 can include instructions that function to control the processor 210 to reformat the intermediate 2D data 250g into a 3D data format. As an example, the feature generation module 280 can reformat the texture information and the semantic information into a suitable 3D format such as a pixel-wise or a point wise feature map using any suitable algorithm. The feature generation module 280 can fuse the intermediate 2D data 250g reformatted into the 3D data format with the intermediate 3D data 250h to create the blended 3D data 250f. As an example, the feature generation module 280 can project the reformatted intermediate 2D data 250g and the intermediate 3D data 250h to a common data space and they can be subsequently combined.

The feature generation module 280 can also include instructions that function to control the processor 210 to reformat the intermediate 3D data 250h into a 2D data format. As an example, the feature generation module 280 can reformat or project the pixel-wise feature map into a 2D image. The feature generation module 280 can down-sample the projected 2D image to the size of the intermediate 2D data 250g, creating a 3D abridged feature map. The feature generation module 280 can apply any suitable down-sampling algorithm such as max-pooling.

The feature generation module 280 can fuse the 3D abridged feature map with the intermediate 2D data 250g to create the blended 2D data 250e. In other words, the feature generation module 280 can generate the blended 2D data 250e based on a fusion of the reformatted intermediate 3D data 250h with the intermediate 2D data 250g. As an example, the feature generation module 280 can project the intermediate 2D data 250g and the reformatted intermediate 3D data 250h to a common data space, and they can be subsequently combined.

The feature generation module 280 includes instructions that function to control the processor 210 to generate 2D features 250c based on the 2D data 250a and the blended 2D data 250e. The feature generation module 280 can use any suitable machine learning model, such as the MASK-RCNN model, to generate 2D features 250c that can include segmentation masks and 3D object orientation estimates.

The feature generation module 280 includes instructions that function to control the processor 210 to generate 3D features 250d based on the 3D data 250b and the blended 3D data 250f. The feature generation module 280 can use any suitable machine learning model, such as a Graph Neural Network (GNN), to generate 3D features 250d such as 3D object center location estimates. A 3D object center location estimate is the estimated distance between the capturing sensor and the estimated center of the object.

The proposal generation module 290 can include instructions to generate 2D object anchor boxes 250j based on the 2D features 250c. The proposal generation module 290 can also include instructions to generate 3D object anchor boxes 250k based on the 3D features 250d. Object anchor boxes are predefined bounding boxes of a certain height and width. The bounding boxes are defined to capture the scale and aspect ratio of specific object classes detected and identified based on applying machine learning processes to feature maps. As such, the 2D object anchor boxes 250j can include bounding boxes that are generated based on the information learned from the 2D features 250c. As an example, the proposal generation module 290 can generate a set of 2D object anchor boxes 250j based on the segmentation masks and the 3D object orientation estimates. The 3D object anchor boxes250k can include bounding boxes that are generated based on information learned from the 2D features 250c and the 3D features 250d. As an example, the proposal generation module 290 can generate a set of 3D object anchor boxes 250k based on the segmentation masks, the 3D object orientation estimates, and the 3D object center location estimates.

The proposal generation module 290 can include instructions that function to control the processor 210 to generate bounding box proposals 140 based on the 2D features 250c and the 3D features 250d. As an example, the proposal generation module 290 can include instructions that function to control the processor 210 to generate the bounding box proposals 140 based on the 2D object anchor boxes 250j and the 3D object anchor boxes 250k. The proposal generation module 290 can use any suitable machine learning module to determine a set of bounding box proposals 140 based on the 2D object anchor boxes 250j and 3D object anchor boxes 250k.

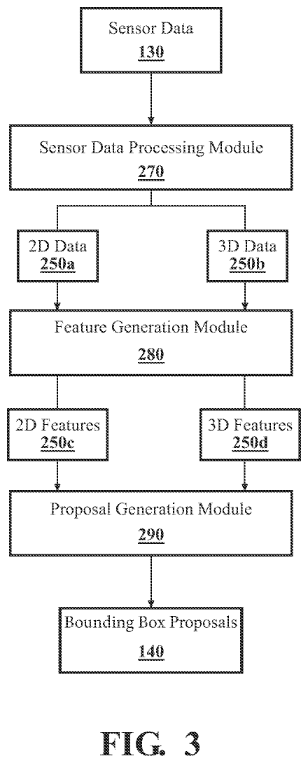

FIG. 3 illustrates one embodiment of a dataflow associated with generating bounding box proposals 140. As shown, the sensor data processing module 270 receives the sensor data 130. The sensor data processing module 270 generates and outputs 2D data 250a and 3D data 250b based on the received sensor data 130. The feature generation module 280 receives the 2D data 250a and the 3D data 250b from the sensor data processing module 270. The feature generation module 280 generates and outputs 2D features 250c and 3D features 250d based on the 2D data 250a and the 3D data 250b. The proposal generation module 290 receives the 2D features 250c and 3D features 250d from the feature generation module 280. The proposal generation module 290 generates and outputs bounding box proposals 140 based on the 2D features 250c and 3D features 250d.

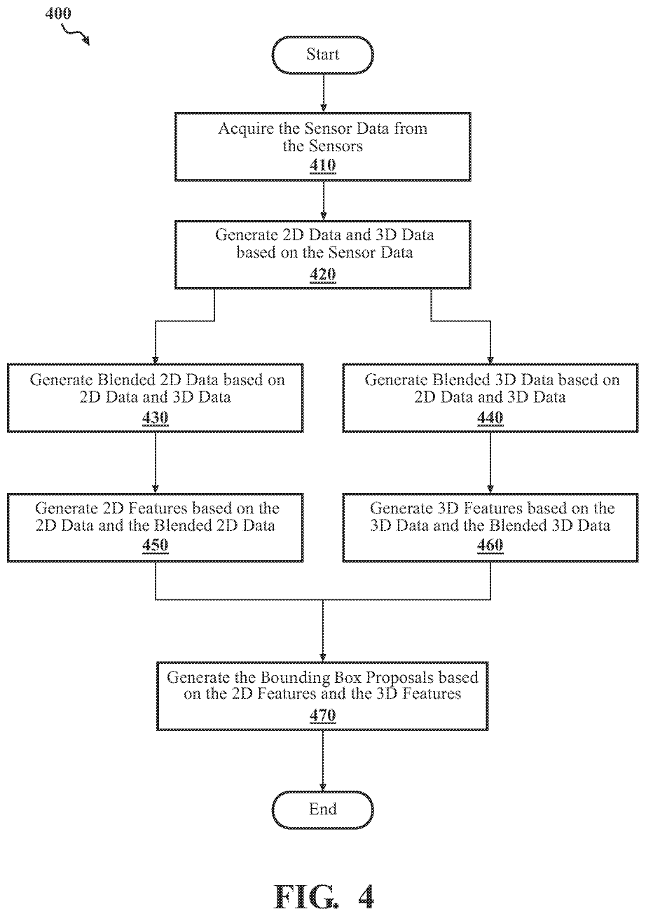

FIG. 4 illustrates a method 400 for generating bounding box proposals 140. The method 400 will be described from the viewpoint of the BBPG system 100 of FIGS. 1 to 3. However, the method 400 may be adapted to be executed in any one of several different situations and not necessarily by the BBPG system 100 of FIGS. 1 to 3.

At step 410, the sensor data processing module 270 may cause the processor 210 to acquire input sensor data 130 from one or more sensors. As previously mentioned, the sensor data processing module 270 may employ active or passive techniques to acquire the input sensor data 130.

At step 420, the sensor data processing module 270 may cause the processor 210 to generate 2D data 250a and 3D data 250b based on the input sensor data 130. More specifically and as described above, the sensor data processing module 270 can extract 2D images such as ambient images, light intensity images, and depth maps from the input sensor data 130. The sensor data processing module 270 can extract 3D point cloud information from the input sensor data 130.

At step 430, the feature generation module 280 may cause the processor 210 to generate blended 2D data 250e based on the 2D data 250a and the 3D data 250b. The feature generation module 280 can process the 2D data 250a to obtain intermediate 2D data 250g. The feature generation module 280 can process the 3D data 250b to obtain intermediate 3D data 250h. As described above, the feature generation module 280 can blend the intermediate 2D data 250g and the intermediate 3D data 250h to generate the blended 2D data 250e.

At step 440, the feature generation module 280 may cause the processor 210 to generate blended 3D data 250f based on the 2D data 250a and the 3D data 250b. As described above, the feature generation module 280 can blend the intermediate 2D data 250g and the intermediate 3D data 250h to generate the blended 3D data 250f.

At step 450, the feature generation module 280 may cause the processor 210 to generate 2D features 250c based on the 2D data 250a and the blended 2D data 250e, as previously disclosed. The 2D features 250c can include segmentation masks and 3D object orientation estimates, as previously discussed.

At step 460, the feature generation module 280 may cause the processor 210 to generate 3D features 250d based on the 3D data 250b and the blended 3D data 250f, as previously disclosed. The 3D features 250d can include 3D point cloud information.

At step 470, the proposal generation module 290 may cause the processor 210 to generate the bounding box proposals based on the 2D features 250c and the 3D features 250d. As described above, the proposal generation module 290 can generate object anchor boxes 250j, 250k based on the 2D features and the 3D features. The proposal generation module 290 can determine the bounding box proposals 140 based on the object anchor boxes 250j, 250k using any suitable machine learning techniques, as previously described.

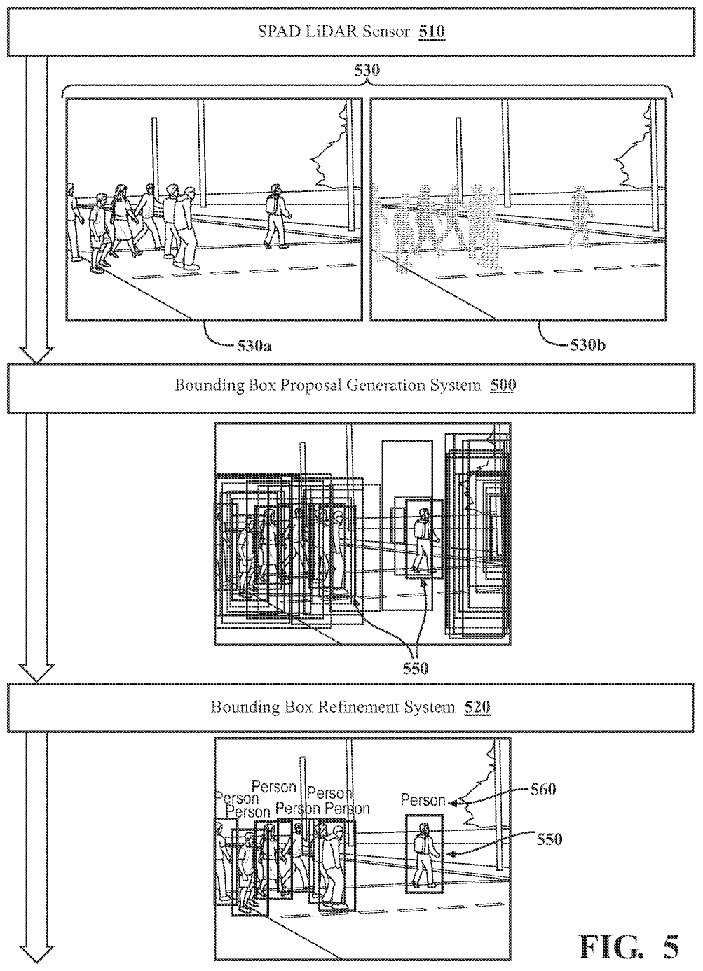

A non-limiting example of the operation of the BBPG system 100 and/or one or more of the methods will now be described in relation to FIG. 5. FIG. 5 shows an example of a bounding box proposal generation scenario.

In FIG. 5, the BBPG system 500, which is similar to the BBPG system 100, receives sensor data 530 from a SPAD LiDAR sensor 510 that is located near a pedestrian crosswalk. More specifically, the sensor data processing module 270 may receive sensor data 530 from the SPAD LiDAR sensor 510. The SPAD LiDAR sensor 510 can generate 2D images 530a similar to camera images and 3D point clouds 530b.

The BBPG system 500, or more specifically the sensor data processing module 270, may extract 2D data 250a and 3D data 250b from the 2D images 530a and the 3D point clouds 530b. The feature generation module 280 can determine intermediate 2D data 250g and intermediate 3D data 250h by applying machine learning algorithms to the 2D data 250a and the 3D data 250b respectively. The feature generation module 280 can blend the intermediate 2D data 250g and the intermediate 3D data 250h into a 2D format, forming the blended 2D data 250e. The feature generation module 280 can blend the intermediate 2D data 250g and the intermediate 3D data 250h into a 3D format, forming the blended 3D data 250f.

The feature generation module 280 can generate 2D features 250c by applying machine learning techniques to the 2D data 250a and the blended 2D data 250e. The 2D features 250c, in this case, can include segmentation masks and 3D object orientation estimates. The segmentation masks can identify and be shaped as the people detected in the sensor data 530a, 530b. The 3D object orientation estimates can provide estimates of the direction the people identified using the segmentation masks are facing. Similarly, the feature generation module 280 can generate 3D features 250d by applying machine learning techniques to the 3D data 250b and the blended 3D data 250f. The 3D features 250d can include 3D object center location estimates for the identified objects, which in this case, are people. As such the 3D object center location estimates can include estimates of the distance between the capturing sensor 510 and the estimated center of the detected person.

The proposal generation module 290 can generate the bounding box proposals 540, similar to the bounding box proposals 140, based on the 2D features 250c and the 3D features 250d. The proposal generation module 290 can generate object anchor boxes 250j, 250k based on the 2D features 250c and the 3D features 250d. More specifically, the proposal generation module 290 can generate the bounding box proposals 540 based on the segmentation masks, the 3D object orientation estimates, and the 3D object center location estimates related to the people detected in the sensor data 530a, 530b. The proposal generation module 290 can generate and output the bounding box proposals 540 based on applying machine learning techniques to the object anchor boxes 250j, 250k. The bounding box refinement system 520 can receive the bounding box proposals as well as any other relevant information. Upon receipt, the bounding box refinement system 520 can associate a bounding box 550 with the objects detected and can also, classify the objects, in this case as people 560.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, another magnetic medium, an ASIC, a CD, another optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that, when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform particular tasks or implement particular data types. In further aspects, a memory generally stores the noted modules. The memory associated with a module may be a buffer or cache embedded within a processor 210, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. A method for generating bounding box proposals comprising:
generating blended 2-dimensional (2D) data based on 2D data and 3-dimensional (3D) data, the 2D data being generated by a sensor capable of generating 2D sensor data and the 3D data being generated by another sensor capable of generating 3D sensor data,
generating blended 3D data based on the 2D data and the 3D data,
generating 2D features based on the 2D data and the blended 2D data,
generating 3D features based on the 3D data and the blended 3D data, and generating the bounding box proposals based on the 2D features and the 3D features.

2. The method of claim 1, wherein generating the blended 2D data includes:
generating intermediate 2D data based on the 2D data,
generating intermediate 3D data based on the 3D data,
reformatting the intermediate 3D data into a 2D data format, and
generating the blended 2D data based on a fusion of the reformatted intermediate 3D data with the intermediate 2D data.

3. The method of claim 1, wherein generating the blended 3D data includes:
generating intermediate 2D data based on the 2D data,
generating intermediate 3D data based on the 3D data,
reformatting the intermediate 2D data into a 3D data format, and
generating the blended 3D data based on a fusion of the reformatted intermediate 2D data with the intermediate 3D data.

4. The method of claim 1, wherein generating the bounding box proposals includes:
generating 2D object anchor boxes based on the 2D features,
generating 3D object anchor boxes based on the 2D features and 3D features, and
generating the bounding box proposals based on the 2D object anchor boxes and the 3D object anchor boxes.

5. The method of claim 1, wherein the 2D features include at least one of segmentation masks and 3D object orientation estimates.

6. The method of claim 1, wherein the 3D features include a 3D object center location estimate.

7. The method of claim 1, wherein the 2D data includes one or more of:
an ambient image, an intensity image, and a depth map.

8. The method of claim 1, wherein the 3D data includes one or more of:
an ambient image, an intensity image, and a 3D point cloud.

9. A system for generating bounding box proposals comprising:
a processor; and
a memory in communication with the processor, the memory including:
a feature generation module including instructions that when executed by the processor cause the processor to:
generate blended 2D data based on 2D data and 3D data, the 2D data being generated by a sensor capable of generating 2D sensor data and the 3D data being generated by another sensor capable of generating 3D sensor data;
generate blended 3D data based on the 2D data and the 3D data;
generate 2D features based on the 2D data and the blended 2D data; and
generate 3D features based on the 3D data and the blended 3D data; and
a proposal generation module including instructions that when executed by the processor cause the processor to generate the bounding box proposals based on the 2D features and the 3D features.

10. The system of claim 9, wherein the instructions to generate the blended 2D data further include instructions to:
generate intermediate 2D data based on the 2D data;
generate intermediate 3D data based on the 3D data;
reformat the intermediate 3D data into a 2D data format; and
generate the blended 2D data based on a fusion of the reformatted intermediate 3D data with the intermediate 2D data.

11. The system of claim 9, wherein the instructions to generate the blended 3D data further include instructions to:
generate intermediate 2D data based on the 2D data;
generate intermediate 3D data based on the 3D data;
reformat the intermediate 2D data into a 3D data format; and
generate the blended 3D data based on a fusion of the reformatted intermediate 2D data with the intermediate 3D data.

12. The system of claim 9, wherein the instructions to generate the bounding box proposals further include instructions to:
generate 2D object anchor boxes based on the 2D features;
generate 3D object anchor boxes based on the 2D features and 3D features; and
generate the bounding box proposals based on the 2D object anchor boxes and the 3D object anchor boxes.

13. The system of claim 9, wherein the 2D features include at least one of segmentation masks and 3D object orientation estimates.

14. The system of claim 9, wherein the 3D features include a 3D object center location estimate.

15. The system of claim 9, wherein the 2D data includes one or more of:
an ambient image, an intensity image, and a depth map.

16. The system of claim 9, wherein the 3D data includes one or more of:
an ambient image, an intensity image, and a 3D point cloud.

17. A non-transitory computer-readable medium for generating bounding box proposals and including instructions that when executed by a processor cause the processor to:
generate blended 2D data based on 2D data and 3D data, the 2D data being generated by a sensor capable of generating 2D sensor data and the 3D data being generated by another sensor capable of generating 3D sensor data;
generate blended 3D data based on the 2D data and the 3D data;
generate 2D features based on the 2D data and the blended 2D data;
generate 3D features based on the 3D data and the blended 3D data; and
generate the bounding box proposals based on the 2D features and the 3D features.

18. The non-transitory computer-readable medium of claim 17, wherein the instructions further include instructions to:
generate intermediate 2D data based on the 2D data;
generate intermediate 3D data based on the 3D data;
reformat the intermediate 3D data into a 2D data format; and
generate the blended 2D data based on a fusion of the reformatted intermediate 3D data with the intermediate 2D data.

19. The non-transitory computer-readable medium of claim 17, wherein the instructions further include instructions to:
generate intermediate 2D data based on the 2D data;
generate intermediate 3D data based on the 3D data;
reformat the intermediate 2D data into a 3D data format; and
generate the blended 3D data based on a fusion of the reformatted intermediate 2D data with the intermediate 3D data.

20. The non-transitory computer-readable medium of claim 17, wherein the instructions further include instructions to:
generate 2D object anchor boxes based on the 2D features;
generate 3D object anchor boxes based on the 2D features and 3D features; and
generate the bounding box proposals based on the 2D object anchor boxes and the 3D object anchor boxes.
